(19) United States
(12) Patent Application Publication
(10) Pub. No.: US 2026/0076336 A1
(43) Pub. Date: Mar. 19, 2026

(54) LEAK-PROOF PEE PAD

(71) Applicant: JIANGSU ZHONGHENG PET ARTICLES JOINT-STOCK CO., LTD., Yancheng (CN)

(72) Inventor: Bin QIU, Yancheng (CN)

(73) Assignee: JIANGSU ZHONGHENG PET ARTICLES JOINT-STOCK CO., LTD., Yancheng (CN)

(21) Appl. No.: 19/026,574

(22) Filed: Jan. 17, 2025

(30) Foreign Application Priority Data
Sep. 18, 2024 (CN) 202422282778.8

(51) Int. Cl. A01K 1/01; B32B 3/04; B32B 3/08; B32B 5/02; B32B 27/10; B32B 27/32; B32B 29/00; B32B 29/02

(52) U.S. Cl. CPC A01K 1/0107; B32B 3/04; B32B 3/08; B32B 5/022; B32B 27/10; B32B 27/32; B32B 29/005; B32B 29/02; B32B 2250/44; B32B 2262/0253; B32B 2307/726; B32B 2307/7265; B32B 2471/00

(57) ABSTRACT

A leak-proof pee pad includes an impermeable layer; an absorbent layer provided on a surface of the impermeable layer; and a side enclosing assembly connected to the impermeable layer and/or the absorbent layer. The side enclosing assembly is provided on the impermeable layer or the absorbent layer, so that the side enclosing assembly can intercept urine flowing to an edge of the absorbent layer, preventing the urine from flowing to the ground and reducing the impact of the urine on environmental hygiene.

### CROSS REFERENCE TO THE RELATED APPLICATIONS

This application is based upon and claims priority to Chinese Patent Application No. 202422282778.8, filed on Sep. 18, 2024, the entire contents of which are incorporated herein by reference.

### TECHNICAL FIELD

The present disclosure relates to the field of pet supplies, and in particular, to a leak-proof pee pad.

### BACKGROUND

Pet pee pads are disposable sanitary products designed specifically for pet dogs or pet cats, and have extremely strong and safe absorption capacity. A specially designed surface material is used in the pet pee pads to keep the pet pee pads dry for a long time, thereby maintaining household cleanliness and hygiene.

However, in conventional pet pee pads, the edges are not enclosed, or only two opposite side edges are enclosed. Therefore, when there is a lot of urine from a pet, the urine will flow out from the unenclosed edges of the pee pad to affect environmental hygiene.

### SUMMARY

In order to solve the technical problem that when there is a lot of urine from a pet, the urine is prone to flowing out from an unenclosed edge of a pee pad to affect environmental hygiene, an objective of the present disclosure is to provide a leak-proof pee pad.

To achieve the above objective, an embodiment of the present disclosure provides a leak-proof pee pad. The leak-proof pee pad includes:
an impermeable layer;
an absorbent layer, where the absorbent layer is provided on a surface of the impermeable layer; and
a side enclosing assembly, where the side enclosing assembly is connected to the impermeable layer and/or the absorbent layer.

In the above technical solution, the side enclosing assembly includes:
two first side enclosing members, where the two first side enclosing members are symmetrically arranged above the impermeable layer, and the two first side enclosing members are partially fixedly connected to the impermeable layer and the absorbent layer; and
two second side enclosing members, where the two second side enclosing members are symmetrically arranged above the impermeable layer, two ends of each of the two second side enclosing members are fixedly connected to the two first side enclosing members, respectively, and the two second side enclosing members are partially fixedly connected to the impermeable layer and the absorbent layer.

In the above technical solution, each of the two first side enclosing members has a length greater than a length of a respective side of the impermeable layer; and
each of the two second side enclosing members has a length greater than a length of a respective side of the impermeable layer.

In the above technical solution, a side of each of the two first side enclosing members adjacent to a center of the impermeable layer and a side of each of the two second side enclosing members adjacent to the center of the impermeable layer are fixedly connected to elastic members, respectively.

In the above technical solution, each of the two first side enclosing members has a length equal to a length of a respective side of the impermeable layer; and
each of the two second side enclosing members has a length equal to a length of a respective side of the impermeable layer.

In the above technical solution, the two second side enclosing members are integrally formed with the impermeable layer.

In the above technical solution, the side enclosing assembly includes:
two first side enclosing members, where the two first side enclosing members are symmetrically arranged above the impermeable layer, and the two first side enclosing members are partially fixedly connected to the absorbent layer; and
two second side enclosing members, where the two second side enclosing members are symmetrically arranged above the impermeable layer, two ends of each of the two second side enclosing members are fixedly connected to the two first side enclosing members, respectively, and the two second side enclosing members are partially fixedly connected to the absorbent layer.

In the above technical solution, each of the two first side enclosing members has a length greater than a length of a respective side of the absorbent layer; and
each of the two second side enclosing members has a length greater than a length of a respective side of the absorbent layer.

In the above technical solution, a side of each of the two first side enclosing members adjacent to a center of the impermeable layer and a side of each of the two second side enclosing members adjacent to the center of the impermeable layer are fixedly connected to elastic members, respectively.

In the above technical solution, each of the two first side enclosing members has a length equal to a length of a respective side of the absorbent layer; and
each of the two second side enclosing members has a length equal to a length of a respective side of the absorbent layer.

In the above technical solution, the two second side enclosing members are integrally formed with the absorbent layer.

Additional aspects and advantages of the present disclosure will become apparent in the following description or will be understood through the practice of the present disclosure.

### BRIEF DESCRIPTION OF THE DRAWINGS

The above and/or additional aspects and advantages of the present disclosure will become apparent and readily comprehensible from the description of embodiments in reference with the following drawings, where

FIG. 1 is a front sectional schematic structural diagram of a middle of a leak-proof pee pad according to Embodiment 1 of the present disclosure.

FIG. 2 is a front sectional schematic structural diagram of an edge of the leak-proof pee pad according to Embodiment 1 of the present disclosure.

FIG. 3 is a front schematic structural diagram of the leak-proof pee pad according to Embodiment 1 of the present disclosure.

FIG. 4 is a top schematic structural diagram of the leak-proof pee pad according to Embodiment 1 of the present disclosure.

FIG. 5 is an enlarged schematic structural diagram of part A of the leak-proof pee pad according to Embodiment 1 of the present disclosure.

FIG. 6 is a front sectional schematic structural diagram of a middle of a leak-proof pee pad according to Embodiment 2 of the present disclosure.

FIG. 7 is a front sectional schematic structural diagram of an edge of the leak-proof pee pad according to Embodiment 2 of the present disclosure.

FIG. 8 is a front schematic structural diagram of the leak-proof pee pad according to Embodiment 2 of the present disclosure.

FIG. 9 is a top schematic structural diagram of the leak-proof pee pad according to Embodiment 2 of the present disclosure.

FIG. 10 is a left sectional schematic structural diagram of the middle of the leak-proof pee pad according to Embodiment 2 of the present disclosure.

FIG. 11 is a left sectional schematic structural diagram of the edge of the leak-proof pee pad according to Embodiment 2 of the present disclosure.

FIG. 12 is a left schematic structural diagram of the leak-proof pee pad according to Embodiment 2 of the present disclosure.

FIG. 13 is a front sectional schematic structural diagram of a middle of a leak-proof pee pad according to Embodiment 3 of the present disclosure.

FIG. 14 is a front sectional schematic structural diagram of an edge of the leak-proof pee pad according to Embodiment 3 of the present disclosure.

FIG. 15 is a front schematic structural diagram of the leak-proof pee pad according to Embodiment 3 of the present disclosure.

FIG. 16 is a top schematic structural diagram of the leak-proof pee pad according to Embodiment 3 of the present disclosure.

FIG. 17 is a front sectional schematic structural diagram of a middle of a leak-proof pee pad according to Embodiment 4 of the present disclosure.

FIG. 18 is a front sectional schematic structural diagram of an edge of the leak-proof pee pad according to Embodiment 4 of the present disclosure.

FIG. 19 is a front schematic structural diagram of the leak-proof pee pad according to Embodiment 4 of the present disclosure.

FIG. 20 is a top schematic structural diagram of the leak-proof pee pad according to Embodiment 4 of the present disclosure.

FIG. 21 is a left sectional schematic structural diagram of the middle of the leak-proof pee pad according to Embodiment 4 of the present disclosure.

FIG. 22 is a left sectional schematic structural diagram of the edge of the leak-proof pee pad according to Embodiment 4 of the present disclosure.

FIG. 23 is a left schematic structural diagram of the leak-proof pee pad according to Embodiment 4 of the present disclosure.

### DETAILED DESCRIPTION OF THE EMBODIMENTS

To understand the above objectives, features, and advantages of the present disclosure more clearly, the present disclosure is further described in detail below with reference to the drawings and specific implementations. It should be noted that the embodiments of the present disclosure and features of the embodiments may be combined with each other in case of no conflict.

Many specific details are set forth in the following description to facilitate a full understanding of the present disclosure. However, the present disclosure can also be implemented in other ways different from those described herein. Therefore, the protection scope of the present disclosure is not limited by the specific embodiments disclosed below.

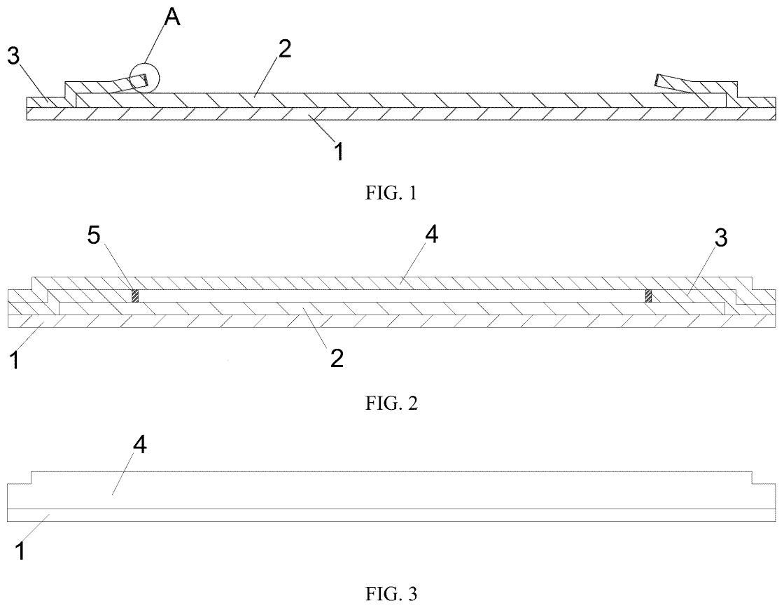

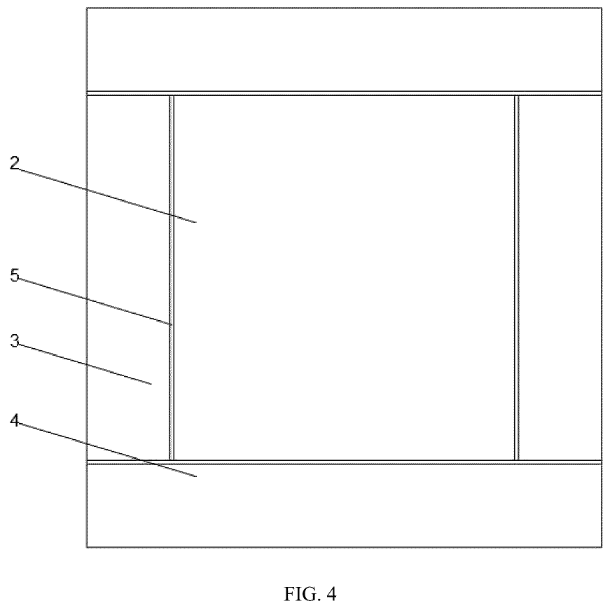

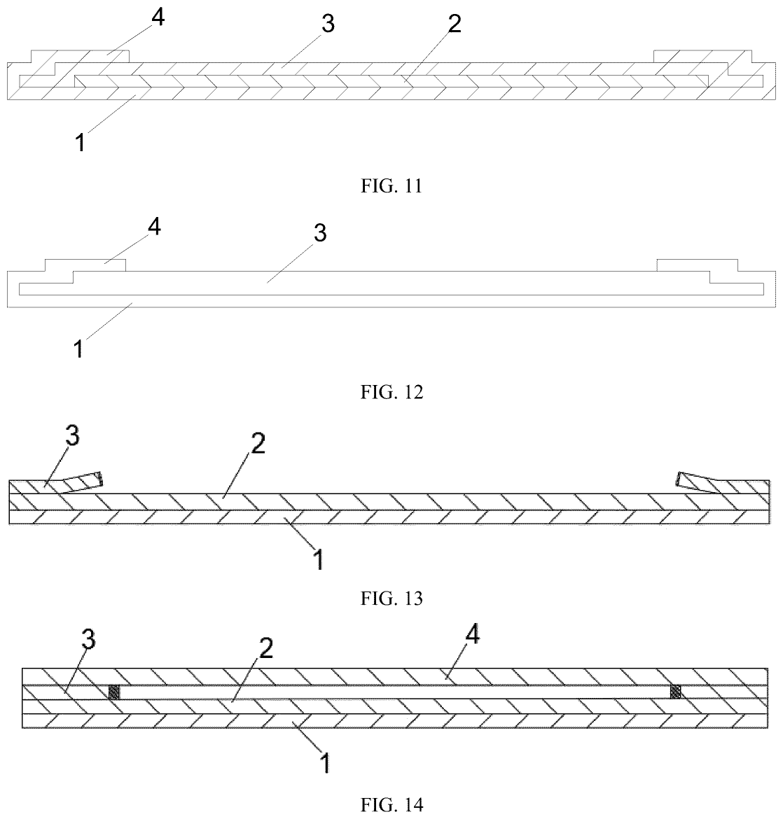

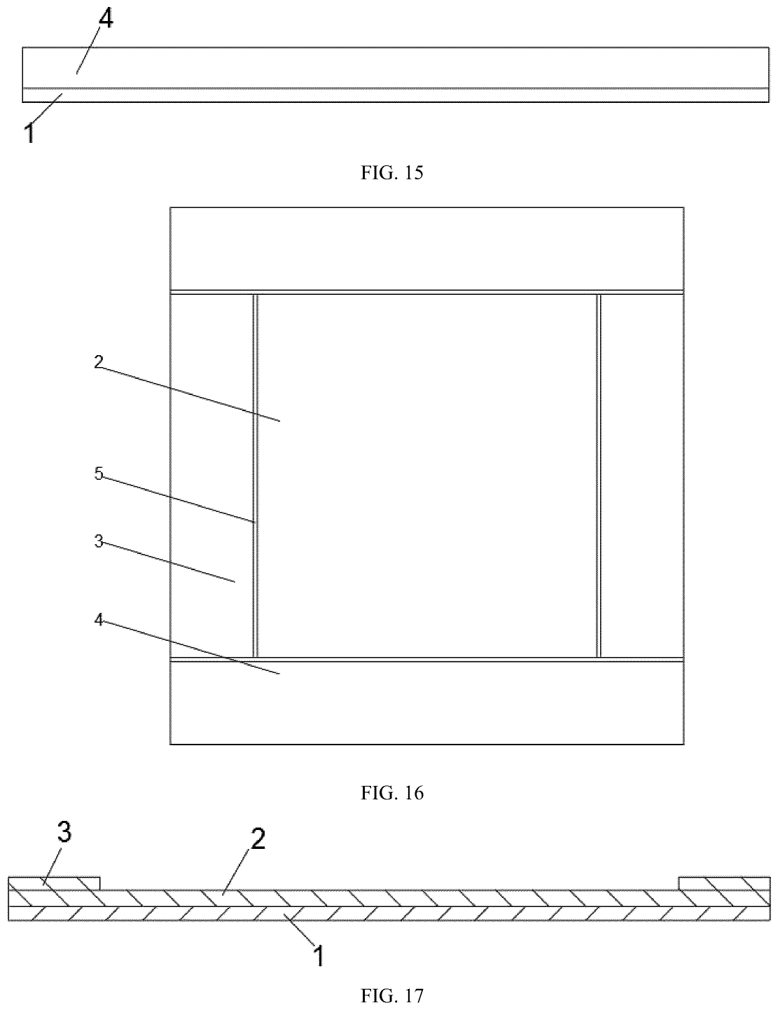

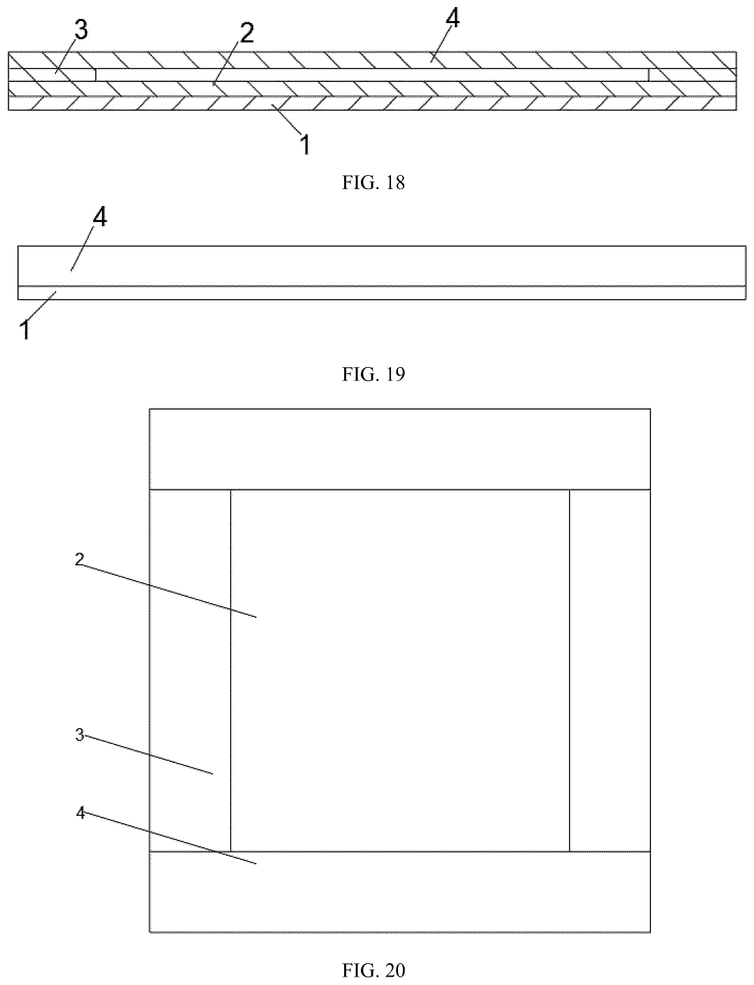

Some embodiments of the leak-proof pee pad according to the present disclosure are described below with reference to FIGS. 1 to 23.

As shown in FIGS. 1 to 23, an embodiment of the present disclosure provides a leak-proof pee pad, including an impermeable layer 1; an absorbent layer 2 provided on an upper surface of the impermeable layer 1; and a side enclosing assembly fixedly connected to the impermeable layer and/or the absorbent layer. The side enclosing assembly can be fixedly connected to an edge of the impermeable layer 1 and/or an edge of the absorbent layer 2. The side enclosing assembly can also be fixedly connected to a non-edge position of the impermeable layer 1 or a non-edge position of the absorbent layer 2. When the side enclosing assembly is fixedly connected to a non-edge position of the impermeable layer 1 or a non-edge position of the absorbent layer 2, a space enclosed by a side of the side enclosing assembly adjacent to a center of the impermeable layer 1 needs to be sufficient for a pet to pee, in order to avoid urine being spilled directly out of the side enclosing assembly. A distance between a side of the side enclosing assembly distant from the center of the impermeable layer 1 and a respective edge of the impermeable layer 1 is 0-10 cm, and the specific value of the distance depends on an actual usage situation.

The impermeable layer 1 is made of a polyethylene (PE) cast film, and urine is completely absorbed in the absorbent layer 2, and the PE cast film plays a role in preventing leakage. The absorbent layer 2 is provided on the surface of the impermeable layer 1, and the absorbent layer 2 includes a polypropylene (PP) non-woven fabric, a tissue paper layer, a wood pulp layer, and a tissue paper layer in sequence. Thus, when urine enters the absorbent layer 2, the PP non-woven fabric cannot absorb the urine, but the urine can pass through the PP non-woven fabric to enter the tissue paper layer, the wood pulp layer, and the tissue paper layer in sequence. The two tissue paper layers and the wood pulp layer can quickly absorb the urine, and the PP non-woven fabric can protect the tissue paper layers, avoiding pilling and damage of the tissue paper layers due to friction. The side enclosing assembly is provided at the edge of the impermeable layer 1 or the edge of the absorbent layer 2, so that the side enclosing assembly can intercept urine flowing to the edge of the absorbent layer 2, thereby preventing the urine from flowing to the ground and reducing the impact of the urine on environmental hygiene.

### Embodiment 1

As shown in FIGS. 1 to 4, in an embodiment of the present disclosure, the side enclosing assembly includes two first side enclosing members 3 and two second side enclosing members 4. The two first side enclosing members 3 at respective ends thereof distant from a center of the absorbent layer 2 are fixedly connected to one pair of sides of the impermeable layer 1 and one pair of sides of the absorbent layer 2, respectively. The two second side enclosing members 4 are respectively provided on the other pair of sides of the impermeable layer 1. Two ends of each of the two second side enclosing members 4 are fixedly connected to the two first side enclosing members 3, respectively. The two second side enclosing members 4 at respective ends thereof distant from the center of the absorbent layer 2 are fixedly connected to the other pair of sides of the impermeable layer 1 and the other pair of sides of the absorbent layer 2, respectively. In a horizontal direction, the impermeable layer 1 has an area greater than an area of the absorbent layer 2, and the absorbent layer 2 is fixedly connected to a center of the upper surface of the impermeable layer 1. Each of the two first side enclosing members 3 has a length greater than a length of a respective side of the impermeable layer 1, and each of the two second side enclosing members 4 has a length greater than a length of a respective side of the impermeable layer 1.

The two first side enclosing members 3 respectively cover one pair of sides of the impermeable layer 1 and one pair of sides of the absorbent layer 2. A side of each of the two first side enclosing members 3 distant from the center of the impermeable layer 1 is fixedly connected to an edge of the impermeable layer 1 and an edge of the absorbent layer 2, and a side of each of the two first side enclosing members 3 adjacent to the center of the impermeable layer 1 is not connected to the impermeable layer 1 and the absorbent layer 2. The two second side enclosing members 4 respectively cover the other pair of sides of the impermeable layer 1, and the two ends of each of the two second side enclosing members 4 are fixedly connected to the two first side enclosing members 3, respectively. A side of each of the two second side enclosing members 4 distant from the center of the impermeable layer 1 is fixedly connected to an edge of the impermeable layer 1 and an edge of the absorbent layer 2, and a side of each of the two second side enclosing members 4 adjacent to the center of the impermeable layer 1 is not connected to the impermeable layer 1 and the absorbent layer 2. Since the length of each of the two first side enclosing members 3 is greater than the length of the respective side of the impermeable layer 1, the side of each of the two first side enclosing members 3 adjacent to the center of the impermeable layer 1 is raised up, leaving a gap between the side of each of the two first side enclosing members 3 adjacent to the center of the impermeable layer 1 and the impermeable layer 1. Since the length of each of the two second side enclosing members 4 is greater than the length of the respective side of the impermeable layer 1, the side of each of the two second side enclosing members 4 adjacent to the center of the impermeable layer 1 is raised up, leaving a gap between the side of each of the two second side enclosing members 4 adjacent to the center of the impermeable layer 1 and the impermeable layer 1. Thus, when there is too much urine flowing towards the four sides of the absorbent layer 2, the urine can flow into the gap. In addition, the side of each of the two first side enclosing members 3 distant from the center of the impermeable layer 1 is fixedly connected to the impermeable layer 1, and the side of each of the two second side enclosing members 4 distant from the center of the impermeable layer 1 is fixedly connected to the impermeable layer 1. In this way, the two first side enclosing members 3 and the two second side enclosing members 4 can intercept the urine and prevent the urine from flowing to the ground from the two first side enclosing members 3 and the two second side enclosing members 4. Therefore, by intercepting urine in all directions by the two first side enclosing members 3 and the two second side enclosing members 4, the urine can be prevented from flowing from the pee pad to the ground, reducing the impact of the urine on the environmental hygiene.

It should be noted that the two first side enclosing members 3 and the two second side enclosing members 4 are each made of a non-woven fabric. By treating the non-woven fabric with a waterproofing agent, the non-woven fabric has a waterproof function, further playing a role in obstructing urine.

In addition, a distance from each of the two first side enclosing members 3 and the two second side enclosing members 4 to the edge of the respective side of the impermeable layer 1 is 0-10 cm. For example, a distance between the first side enclosing member 3 on the left and the edge of a left side of the impermeable layer 1 is 5 cm, and a distance between the first side enclosing member 3 on the right and the edge of a right side of the impermeable layer 1 is 5 cm. In addition, a distance between the second side enclosing member 4 at a front end and the edge of a front side of the impermeable layer 1 is 5 cm, and a distance between the second side enclosing member 4 at a rear end and the edge of a rear side of the impermeable layer 1 is 5 cm. In this case, the principle of intercepting urine by the two first side enclosing members 3 and the two second side enclosing members 4 is the same as the above principle, and will not be further elaborated here.

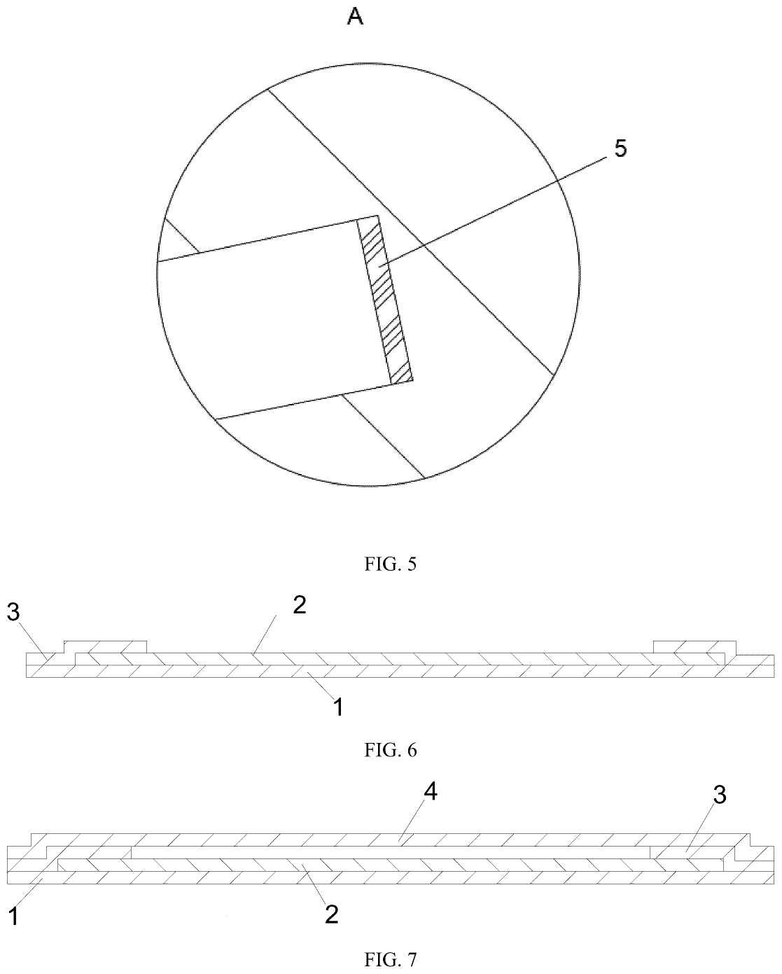

As shown in FIG. 5, in an embodiment of the present disclosure, the side of each of the two first side enclosing members 3 adjacent to the center of the impermeable layer 1 and the side of each of the two second side enclosing members 4 adjacent to the center of the impermeable layer 1 are fixedly connected to elastic members 5, respectively.

The side of each of the two first side enclosing members 3 adjacent to the center of the impermeable layer 1 and the side of each of the two second side enclosing members 4 adjacent to the center of the impermeable layer 1 are fixedly connected to the elastic members 5, respectively. When the elastic members 5 are in a slack state, each of the elastic members 5 has a length smaller than a length of a respective one of the two first side enclosing members 3 and the two second side enclosing members 4. However, when the elastic members 5 are fixedly connected to the two first side enclosing members 3 and the two second side enclosing members 4, respectively, the elastic members 5 are in a tight state, so that the elastic members 5 have a tensile force on the two first side enclosing members 3 and the two second side enclosing members 4 respectively. Therefore, the elastic members 5 pull the two first side enclosing members 3 and the two second side enclosing members 4 respectively, ensuring that the two first side enclosing members 3 and the two second side enclosing members 4 are raised up. In this way, urine can smoothly enter between the first side enclosing members 3 and the absorbent layer 2, as well as between the second side enclosing members 4 and the absorbent layer 2, further reducing urine leakage.

### Embodiment 2

As shown in FIGS. 6 to 12, in an embodiment of the present disclosure, the side enclosing assembly includes two first side enclosing members 3 and two second side enclosing members 4. The two first side enclosing members 3 at respective ends thereof distant from a center of the absorbent layer 2 are fixedly connected to one pair of sides of the impermeable layer 1 and one pair of sides of the absorbent layer 2, respectively. The two second side enclosing members 4 are respectively provided on the other pair of sides of the impermeable layer 1. Two ends of each of the two second side enclosing members 4 are fixedly connected to the two first side enclosing members 3, respectively. The two second side enclosing members 4 at respective ends thereof distant from the center of the absorbent layer 2 are fixedly connected to the other pair of sides of the impermeable layer 1 and the other pair of sides of the absorbent layer 2, respectively. In a horizontal direction, the impermeable layer 1 has an area greater than an area of the absorbent layer 2, and the absorbent layer 2 is fixedly connected to a center of the upper surface of the impermeable layer 1.

The two first side enclosing members 3 respectively cover one pair of sides of the impermeable layer 1 and one pair of sides of the absorbent layer 2. A side of each of the two first side enclosing members 3 distant from the center of the impermeable layer 1 is fixedly connected to an edge of the impermeable layer 1 and an edge of the absorbent layer 2, and a side of each of the two first side enclosing members 3 adjacent to the center of the impermeable layer 1 is not connected to the impermeable layer 1 and the absorbent layer 2. The two second side enclosing members 4 respectively cover the other pair of sides of the impermeable layer 1, and the two ends of each of the two second side enclosing members 4 are fixedly connected to the two first side enclosing members 3, respectively. A side of each of the two second side enclosing members 4 distant from the center of the impermeable layer 1 is fixedly connected to an edge of the impermeable layer 1 and an edge of the absorbent layer 2, and a side of each of the two second side enclosing members 4 adjacent to the center of the impermeable layer 1 is not connected to the impermeable layer 1 and the absorbent layer 2. Each of the two first side enclosing members 3 has a length equal to a length of a respective side of the impermeable layer 1, and each of the two second side enclosing members 4 has a length equal to a length of a respective side of the impermeable layer 1, so that the side of each of the two first side enclosing members 3 adjacent to the center of the impermeable layer 1 and the side of each of the two second side enclosing members 4 adjacent to the center of the impermeable layer 1 are in contact with the absorbent layer 2. In addition, the two first side enclosing members 3, the two second side enclosing members 4, and the absorbent layer 2 are made of soft materials, leaving a certain gap between the absorbent layer 2 and each of the two first side enclosing members 3, and a certain gap between the absorbent layer 2 and each of the two second side enclosing members 4. In this way, urine can flow into the gap, reducing the outflow of the urine from an edge of the impermeable layer 1. In addition, the two first side enclosing members 3 and the two second side enclosing members 4 each have a certain thickness, so that the side of each of the two first side enclosing members 3 adjacent to the center of the impermeable layer 1 and the side of each of the two second side enclosing members 4 adjacent to the center of the impermeable layer 1 are higher than the absorbent layer 2. Thus, when urine flows to the two first side enclosing members 3 and the two second side enclosing members 4, the two first side enclosing members 3 and the two second side enclosing members 4 can obstruct the urine and prevent the urine from leaking out. Therefore, by intercepting urine in all directions by the two first side enclosing members 3 and the two second side enclosing members 4, the urine can be prevented from flowing from the pee pad to the ground, reducing the impact of the urine on the environmental hygiene.

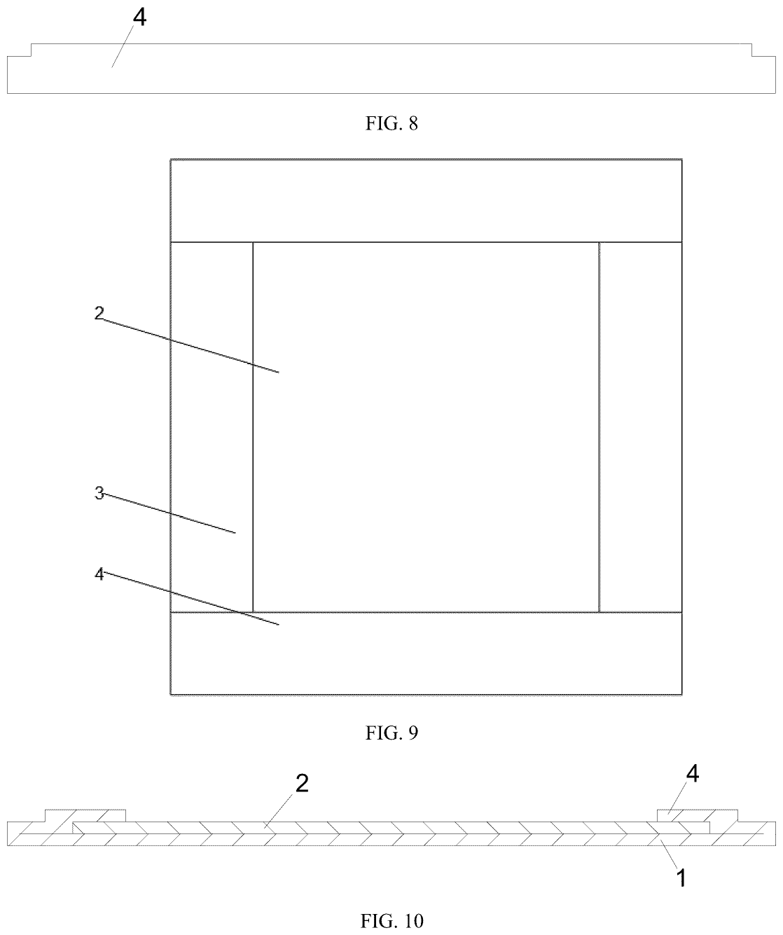

As shown in FIGS. 9 to 12, in an embodiment of the present disclosure, the two second side enclosing members 4 are integrally formed with the impermeable layer 1.

By integrally forming the two second side enclosing members 4 with the impermeable layer 1, processing steps of the two second side enclosing members 4 and the impermeable layer 1 are reduced, simplifying the processing difficulty.

It should be noted that as the two first side enclosing members 3 and the two second side enclosing members 4 are each made of a PE cast film and the two second side enclosing members 4 are integrally formed with the impermeable layer 1, the types of materials used and the processing steps are reduced.

In addition, a distance between the first side enclosing member 3 and the corresponding side of the impermeable layer 1 is 0-10 cm. For example, when the first side enclosing member 3 on the left is fixedly connected at a position 5 cm distant from an edge of a left side of the impermeable layer 1 and the first side enclosing member 3 on the right is fixedly connected at a position 5 cm distant from an edge of a right side of the impermeable layer 1, the principle of intercepting urine by the first side enclosing members 3 on the left and right is the same as the above principle, and will not be further elaborated here.

### Embodiment 3

As shown in FIGS. 13 to 16, in an embodiment of the present disclosure, the side enclosing assembly includes two first side enclosing members 3 and two second side enclosing members 4. The two first side enclosing members 3 at respective ends thereof distant from a center of the absorbent layer 2 are fixedly connected to one pair of sides of the absorbent layer 2, respectively. The two second side enclosing members 4 are respectively provided on the other pair of sides of the absorbent layer 2. Two ends of each of the two second side enclosing members 4 are fixedly connected to the two first side enclosing members 3, respectively. The two second side enclosing members 4 at respective ends thereof distant from the center of the absorbent layer 2 are fixedly connected to the other pair of sides of the absorbent layer 2, respectively. Each of the two first side enclosing members 3 has a length greater than a length of a respective side of the absorbent layer 2, and each of the two second side enclosing members 4 has a length greater than a length of a respective side of the absorbent layer 2. In a horizontal direction, the impermeable layer 1 has an area equal to an area of the absorbent layer 2.

The two first side enclosing members 3 respectively cover one pair of sides of the absorbent layer 2. A side of each of the two first side enclosing members 3 distant from the center of the impermeable layer 1 is fixedly connected to an edge of the absorbent layer 2, and a side of each of the two first side enclosing members 3 adjacent to the center of the impermeable layer 1 is not connected to the absorbent layer 2. The two second side enclosing members 4 respectively cover the other pair of sides of the absorbent layer 2, and two ends of each of the two second side enclosing members 4 are fixedly connected to the two first side enclosing members 3, respectively. A side of each of the two second side enclosing members 4 distant from the center of the impermeable layer 1 is fixedly connected to an edge of the absorbent layer 2, and a side of each of the two second side enclosing members 4 adjacent to the center of the absorbent layer 2 is not connected to the absorbent layer 2. Since the length of each of the two first side enclosing members 3 is greater than the length of the respective side of the absorbent layer 2, the side of each of the two first side enclosing members 3 adjacent to the center of the absorbent layer 2 is raised up, leaving a gap between the side of each of the two first side enclosing members 3 adjacent to the center of the absorbent layer 2 and the absorbent layer 2. Since the length of each of the two second side enclosing members 4 is greater than the length of the respective side of the absorbent layer 2, the side of each of the two second side enclosing members 4 adjacent to the center of the absorbent layer 2 is raised up, leaving a gap between the side of each of the two second side enclosing members 4 adjacent to the center of the absorbent layer 2 and the absorbent layer 2. Thus, when there is too much urine flowing towards the four sides of the absorbent layer 2, the urine can flow into the gap. In addition, the side of each of the two first side enclosing members 3 distant from the center of the absorbent layer 2 is fixedly connected to the absorbent layer 2, and the side of each of the two second side enclosing members 4 distant from the center of the absorbent layer 2 is fixedly connected to the absorbent layer 2. In this way, the two first side enclosing members 3 and the two second side enclosing members 4 can intercept the urine and prevent the urine from flowing to the ground from the two first side enclosing members 3 and the two second side enclosing members 4. Therefore, by intercepting urine in all directions by the two first side enclosing members 3 and the two second side enclosing members 4, the urine can be prevented from flowing from the pee pad to the ground, reducing the impact of the urine on the environmental hygiene.

It should be noted that the two first side enclosing members 3 and the two second side enclosing members 4 are made of the same material as the absorbent layer 2, so that the two first side enclosing members 3 and the two second side enclosing members 4 can further absorb urine during the interception process.

In addition, a distance from each of the two first side enclosing members 3 and the two second side enclosing members 4 to the edge of the respective side of the impermeable layer 1 is 0-10 cm. For example, a distance between the first side enclosing member 3 on the left and the edge of a left side of the impermeable layer 1 is 5 cm, and a distance between the first side enclosing member 3 on the right and the edge of a right side of the impermeable layer 1 is 5 cm. In addition, a distance between the second side enclosing member 4 at a front end and the edge of a front side of the impermeable layer 1 is 5 cm, and a distance between the second side enclosing member 4 at a rear end and the edge of a rear side of the impermeable layer 1 is 5 cm. In this case, the principle of intercepting urine by the two first side enclosing members 3 and the two second side enclosing members 4 is the same as the above principle, and will not be further elaborated here.

As shown in FIG. 16, in an embodiment of the present disclosure, the side of each of the two first side enclosing members 3 adjacent to the center of the impermeable layer 1 and the side of each of the two second side enclosing members 4 adjacent to the center of the impermeable layer 1 are fixedly connected to elastic members 5, respectively.

The side of each of the two first side enclosing members 3 adjacent to the center of the absorbent layer 2 and the side of each of the two second side enclosing members 4 adjacent to the center of the absorbent layer 2 are fixedly connected to the elastic members 5, respectively. When the elastic members 5 are in a slack state, each of the elastic members 5 has a length smaller than a length of a respective one of the two first side enclosing members 3 and the two second side enclosing members 4. However, when the elastic members 5 are fixedly connected to the two first side enclosing members 3 and the two second side enclosing members 4, respectively, the elastic members 5 are in a tight state, so that the elastic members 5 have a tensile force on the two first side enclosing members 3 and the two second side enclosing members 4 respectively. Therefore, the elastic members 5 pull the two first side enclosing members 3 and the two second side enclosing members 4 respectively, ensuring that the two first side enclosing members 3 and the two second side enclosing members 4 are raised up. In this way, urine can smoothly enter between the first side enclosing members 3 and the absorbent layer 2, as well as between the second side enclosing members 4 and the absorbent layer 2, further reducing urine leakage.

### Embodiment 4

As shown in FIGS. 17 to 23, in an embodiment of the present disclosure, the side enclosing assembly includes two first side enclosing members 3 and two second side enclosing members 4. The two first side enclosing members 3 at respective ends thereof distant from a center of the absorbent layer 2 are fixedly connected to one pair of sides of the absorbent layer 2, respectively. The two second side enclosing members 4 are respectively provided on the other pair of sides of the absorbent layer 2. Two ends of each of the two second side enclosing members 4 are fixedly connected to the two first side enclosing members 3, respectively. The two second side enclosing members 4 at respective ends thereof distant from the center of the absorbent layer 2 are fixedly connected to the other pair of sides of the absorbent layer 2, respectively. Each of the two first side enclosing members 3 has a length equal to a length of a respective side of the absorbent layer 2, and each of the two second side enclosing members 4 has a length equal to a length of a respective side of the absorbent layer 2. In a horizontal direction, the impermeable layer 1 has an area equal to an area of the absorbent layer 2.

The two first side enclosing members 3 respectively cover one pair of sides of the absorbent layer 2. A side of each of the two first side enclosing members 3 distant from the center of the absorbent layer 2 is fixedly connected to an edge of the absorbent layer 2, and a side of each of the two first side enclosing members 3 adjacent to the center of the absorbent layer 2 is not connected to the absorbent layer 2. The two second side enclosing members 4 respectively cover the other pair of sides of the absorbent layer 2, and the two ends of each of the two second side enclosing members 4 are fixedly connected to the two first side enclosing members 3, respectively. A side of each of the two second side enclosing members 4 distant from the center of the absorbent layer 2 is fixedly connected to an edge of the absorbent layer 2, and a side of each of the two second side enclosing members 4 adjacent to the center of the absorbent layer 2 is not connected to the impermeable layer 1 and the absorbent layer 2. Each of the two first side enclosing members 3 has a length equal to a length of a respective side of the absorbent layer 2, and each of the two second side enclosing members 4 has a length equal to a length of a respective side of the absorbent layer 2, so that the side of each of the two first side enclosing members 3 adjacent to the center of the absorbent layer 2 and the side of each of the two second side enclosing members 4 adjacent to the center of the absorbent layer 2 are in contact with the absorbent layer 2. In addition, the two first side enclosing members 3, the two second side enclosing members 4, and the absorbent layer 2 are made of soft materials, leaving a certain gap between the absorbent layer 2 and each of the two first side enclosing members 3, and a certain gap between the absorbent layer 2 and each of the two second side enclosing members 4. In this way, urine can flow into the gap, reducing the outflow of the urine from an edge of the absorbent layer 2. In addition, the two first side enclosing members 3 and the two second side enclosing members 4 each have a certain thickness, so that the side of each of the two first side enclosing members 3 adjacent to the center of the absorbent layer 2 and the side of each of the two second side enclosing members 4 adjacent to the center of the absorbent layer 2 are higher than the absorbent layer 2. Thus, when urine flows to the two first side enclosing members 3 and the two second side enclosing members 4, the two first side enclosing members 3 and the two second side enclosing members 4 can obstruct the urine and prevent the urine from leaking out. Therefore, by intercepting urine in all directions by the two first side enclosing members 3 and the two second side enclosing members 4, the urine can be prevented from flowing from the pee pad to the ground, reducing the impact of the urine on the environmental hygiene.

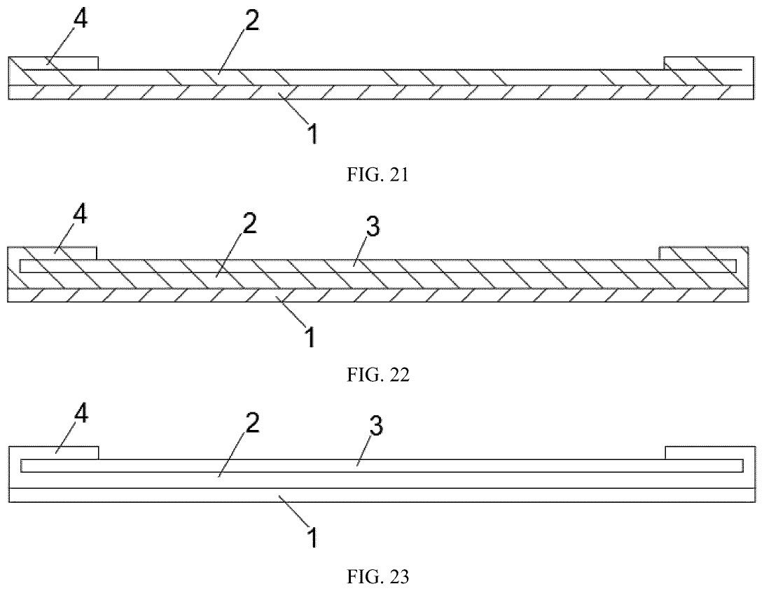

As shown in FIGS. 21 to 23, in an embodiment of the present disclosure, the two second side enclosing members 4 are integrally formed with the absorbent layer 2.

By integrally forming the second side enclosing members 4 with the absorbent layer 2, processing steps of the second side enclosing members 4 and the absorbent layer 2 are reduced, simplifying the processing difficulty.

It should be noted that as the two first side enclosing members 3 and the two second side enclosing members 4 are made of the same material as the absorbent layer 2 and the two second side enclosing members 4 are integrally formed with the impermeable layer 1, the types of materials used and the processing steps are reduced.

In addition, a distance between the first side enclosing member 3 and the corresponding side of the impermeable layer 1 is 0-10 cm. For example, when the first side enclosing member 3 on the left is fixedly connected at a position 5 cm distant from an edge of a left side of the impermeable layer 1 and the first side enclosing member 3 on the right is fixedly connected at a position 5 cm distant from an edge of a right side of the impermeable layer 1, the principle of intercepting urine by the first side enclosing members 3 on the left and right is the same as the above principle, and will not be further elaborated here.

The present disclosure has the following advantages.

The side enclosing assembly is provided at a distance of 0-10 cm from the edge of the impermeable layer 1 or the absorbent layer 2, so that the side enclosing assembly can intercept urine flowing to the edge of the absorbent layer 2, preventing the urine from flowing to the ground and reducing the impact of the urine on environmental hygiene.

In the present disclosure, the terms such as “provided”, “connected to”, “connected”, and “fixed” should be comprehended in a broad sense. For example, “connected” may be comprehended as fixedly connected, detachably connected, or integrally connected, and “connected to” may be directly connected to or indirectly connected to through an intermediary. Those of ordinary skill in the art may understand the specific meanings of the above terms in the present disclosure based on specific situations.

In the description of the present disclosure, it should be understood that orientation or position relationships indicated by terms such as “inside” and “outside” are orientation or position relationships shown in the drawings, and these terms are just used to facilitate description of the present disclosure and simplify the description, but not to indicate or imply that the mentioned apparatus or elements must have a specific orientation and must be constructed and operated in a specific orientation, and thus, these terms cannot be understood as a limitation to the present disclosure.

In the description of this specification, the description with reference to the terms such as “one embodiment”, “some embodiments”, and “a specific embodiment” means that the specific features, structures, materials, or characteristics described with reference to the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

The above are merely preferred embodiments of the present disclosure, and are not intended to limit the present disclosure, and various changes and modifications can be made by those skilled in the art to the present disclosure. Any modifications, equivalent substitutions, improvements, etc. made within the spirit and principle of the present disclosure should be included in the protection scope of the present disclosure.

What is claimed is:

1. A leak-proof pee pad, comprising:
an impermeable layer;
an absorbent layer, wherein the absorbent layer is provided on a surface of the impermeable layer; and
a side enclosing assembly, wherein the side enclosing assembly is connected to the impermeable layer and/or the absorbent layer.

2. The leak-proof pee pad according to claim 1, wherein
the side enclosing assembly comprises:
two first side enclosing members, wherein the two first side enclosing members are symmetrically arranged above the impermeable layer, and the two first side enclosing members are partially fixedly connected to the impermeable layer and the absorbent layer; and
two second side enclosing members, wherein the two second side enclosing members are symmetrically arranged above the impermeable layer, two ends of each of the two second side enclosing members are fixedly connected to the two first side enclosing members, respectively, and the two second side enclosing members are partially fixedly connected to the impermeable layer and the absorbent layer.

3. The leak-proof pee pad according to claim 2, wherein
each of the two first side enclosing members has a length greater than a length of a respective side of the impermeable layer; and
each of the two second side enclosing members has a length greater than the length of the respective side of the impermeable layer.

4. The leak-proof pee pad according to claim 3, wherein
a side of each of the two first side enclosing members adjacent to a center of the impermeable layer and a side of each of the two second side enclosing members adjacent to the center of the impermeable layer are fixedly connected to elastic members, respectively.

5. The leak-proof pee pad according to claim 2, wherein
each of the two first side enclosing members has a length equal to a length of a respective side of the impermeable layer; and
each of the two second side enclosing members has a length equal to the length of the respective side of the impermeable layer.

6. The leak-proof pee pad according to claim 5, wherein
the two second side enclosing members are integrally formed with the impermeable layer.

7. The leak-proof pee pad according to claim 1, wherein
the side enclosing assembly comprises:
two first side enclosing members, wherein the two first side enclosing members are symmetrically arranged above the impermeable layer, and the two first side enclosing members are partially fixedly connected to the absorbent layer; and
two second side enclosing members, wherein the two second side enclosing members are symmetrically arranged above the impermeable layer, two ends of each of the two second side enclosing members are fixedly connected to the two first side enclosing members, respectively, and the two second side enclosing members are partially fixedly connected to the absorbent layer.

8. The leak-proof pee pad according to claim 7, wherein
each of the two first side enclosing members has a length greater than a length of a respective side of the absorbent layer; and
each of the two second side enclosing members has a length greater than the length of the respective side of the absorbent layer.

9. The leak-proof pee pad according to claim 8, wherein
a side of each of the two first side enclosing members adjacent to a center of the impermeable layer and a side of each of the two second side enclosing members adjacent to the center of the impermeable layer are fixedly connected to elastic members, respectively.

10. The leak-proof pee pad according to claim 7, wherein
each of the two first side enclosing members has a length equal to a length of a respective side of the absorbent layer; and
each of the two second side enclosing members has a length equal to the length of the respective side of the absorbent layer.

11. The leak-proof pee pad according to claim 10, wherein
the two second side enclosing members are integrally formed with the absorbent layer.
